(19) United States
(12) Patent Application Publication
(10) Pub. No.: US 2017/0024797 A1
(43) Pub. Date: Jan. 26, 2017

(54) Automated Computer System and Method for Procurement Management

(71) Applicant: Tony Ellison, New York, NY (US)

(72) Inventor: Tony Ellison, New York, NY (US)

(21) Appl. No.: 15/071,846

(22) Filed: Mar. 16, 2016

Related U.S. Application Data
(62) Division of application No. 13/863,284, filed on Apr. 15, 2013.

(51) Int. Cl. G06Q 30/06; G06F 17/30

(52) U.S. Cl. CPC G06Q 30/0631; G06F 17/30864

(57) ABSTRACT

A procurement management system and automated computer-implemented method for providing users with eco-friendly alternatives found in the marketplace. A procurement management system gives businesses of all size the ability to streamline their buying process and make this process more efficient and cost effective. The computer-implemented method is driven by a processor that queries for eco-friendly merchandise, similar to that of the products queried by the user. This automated computer-implemented method calculates and presents to customers (a) the number of trees saved; (b) the number of British Thermal Units saved; (c) the number of gallons of water saved; and (d) the pounds of CO₂ equivalent saved due in part to all such customer purchases of environmentally friendly or “green” products.

### CROSS-REFERENCES TO RELATED APPLICATIONS

This divisional application claims the benefit of U.S. non-provisional application Ser. No. 13/863,284 filed on Apr. 15, 2013, which claims the benefit of U.S. provisional application No. 61/663,303 filed on Jun. 22, 2012, which is herein incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The technology herein relates to a computer implemented procurement and collaboration, and more particularly to methods for facilitating the procurement of items by an enterprise in a coordinated manner. Still more particularly, the example non-limiting technology herein relates to an automated web-based computer system providing tools including environmental functions such as a “green calculator”, a “green yourself” search, an electronic procurement, schedule and save auto replenishment, approved list functionality, and approval routing and merging of orders. Moreover, the present disclosure provides users with suggestions that are comprised of environmental friendly alternatives to products in the stream of commerce.

### BACKGROUND AND SUMMARY

Ordering office and business or other supplies without a methodology or a set of tools presents a series of challenges that businesses must face (e.g., keeping track of supplies ordered and tracking multiple buyers is both difficult and time consuming). Additional dilemmas encountered in the workplace include excess paperwork for reconciling budgets, managing agreements for multiple suppliers, and spending more money with variable pricing. Some larger enterprises provide a centralized point of contact between individual employees and certain suppliers. In such an arrangement, an authorized user must order supplies needed through a centralized point of contact. However, smaller or decentralized enterprises may not provide such a centralized contact point for processing orders. Empowering each individual or department in the enterprise to order supplies can reduce bureaucracy and workflow, but sometimes at the cost of decreased uniformity and inability of the organization to exert control and/or budgeting over what is being ordered.

Additionally, with the world's natural resources depleting at an alarming rate, it is desirable to provide customers with not only environmentally-friendly product alternatives, but the means to easily locate and purchase those products.

The exemplary illustrative non-limiting technology herein solves business procurement problems, contributing these and other quantifiable benefits to businesses:

Lower administrative costs;

Streamline purchase requests and authorizations;

Save time with a single source solution;

Control spend and raise compliance with approved lists;

Set budget and authorizations by location, department, and user;

Run detailed budget and trend analysis reports; and

Benefit from wholesale pricing and automated price alerts.

Non-limiting example systems and methods provide unique automated tools and functionality to replace items in a customer's on-line internet shopping cart with alternative eco-friendly products, In accordance with customers' specific needs, the example non-limiting technology herein can identify the most commonly purchased products (e.g., using an internet website). Because these products may collectively comprise a large percentage of all items sold, the example web tool automatically identifies and specifically targets the products that are most in demand. Moreover, when applicable, the example non-limiting tool automatically presents customers with multiple green alternatives for each of these items, along with explicitly noting which of the alternatives is the “greenest” (i.e., most eco-friendly), While viewing items in their shopping cart, customers can click an appropriate icon and will be presented with side-by-side comparisons between products currently in their carts and environmentally friendly alternatives. In the event shoppers prefer the “green” alternatives, shoppers may substitute non-eco-friendly alternatives with the eco-friendly items at the click of the mouse.

Additional example non-limiting technology herein provides a web-based product search functionality that will enable a customer to provide a product search query into a search data base and then have the option to request search results that are comprised of only eco-friendly products. Such example functionality will process the search request provided by a customer, and provide only correlating eco-friendly products that meet the search criteria. To the extent that no such eco-friendly products match the customer's search criteria, the example non-limiting implementation will prompt the customer with a follow-up request to search an entire product data base—which may potentially contain non-eco-friendly items that match the customer's search query.

Still other example non-limiting implementations provide a unique and example tool that helps enable customers to quantify, in the most meaningful way, how their purchases of eco-friendly and environmentally conscious products have had a positive impact on the environment and the global initiative to conserve the planets natural resources. A unique “green calculator” utilizes a series of mathematical formulas and algorithms to aggregate the purchases of its collective customer base, and dynamically and on a real time basis calculate (a) the number of trees saved; (b) number of BTUs saved; (c) the gallons of water saved; and (d) the pounds of CO₂ equivalent saved due in part to all such customer purchases of eco-friendly products.

### BRIEF DESCRIPTION OF THE DRAWINGS

These and other features and advantages will be better and more completely understood by referring to the following detailed description of example non-limiting embodiments in conjunction with the drawings, of which:

FIG. 1 illustrates an example of an non-limiting computer architecture.

FIG. 2 illustrates a flowchart of an example non-limiting “green your office” programmed control flow.

FIG. 3 illustrates a flowchart of an example non-limiting “green your search” programmed control flow.

FIG. 4 illustrates a flowchart of an example non-limiting “green calculator” programmed control flow.

FIG. 5 illustrates a flowchart of an example non-limiting policies programmed control flow.

FIG. 6 illustrates a flowchart of an example non-limiting multiple users/levels programmed control flow.

FIG. 7 illustrates a flowchart of an example cost centers programmed control flow.

FIG. 8 illustrates a flowchart of an example budgets programmed control flow.

FIG. 9 illustrates a flowchart of an example schedule and save programmed control flow.

FIG. 10 illustrates a flowchart of an example approved list programmed control flow.

FIG. 11 illustrates a flowchart of an example approval routing programmed control flow.

FIG. 12 illustrates a flowchart of an example merging orders programmed control flow.

FIGS. 13-16 illustrate visual depictions and applications of an example non-limiting “green your office” web tool interface on for use on an internet website or other presentation platform.

FIGS. 17-18 illustrate visual depictions and applications of an example non-limiting “green your search” web tool interface.

FIG. 19 illustrates a visual depiction of an example non-limiting “green calculator” interface.

FIG. 20 illustrates a visual depiction of an example non-limiting customer's account center interface where all of the example tools, features and options of the eProcurement platform may be navigated and utilized.

FIG. 21 illustrates a visual depiction of an example non-limiting “schedule & save” interface.

FIG. 22 illustrates a visual depiction of an example non-limiting “approve list” interface.

FIG. 23 illustrates a visual depiction of an example “approval routing and merging of orders” interface.

### DETAILED DESCRIPTION

Various aspects and embodiments of the present disclosure will now be described in detail with reference to the accompanying figures. Certain terminology is used herein for convenience only and is not to be taken as a limitation on the present disclosure. The terminology includes the words specifically mentioned, derivatives thereof and words of similar import. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

### Glossary

“Non-Transitory,” as used herein, excludes only a transitory, propagating signal per se.

“Non-Transitory Storage Medium,” as used herein, refers to any kind of non-transitory storage technology including but not limited to semiconductor memory of any form (including but not limited to read only memory, programmable read only memory, electrically erasable programmable read only memory, programmable gate arrays, random access memory, magnetic memory, bubble memory, etc., whether volatile or non-volatile); optical memory including but not limited to optical disks whether writable and/or erasable; magnetic storage; display storage; and storage of any kind of information on any kind of writable, erasable and/or readable carrier, device or medium of any form whatsoever.

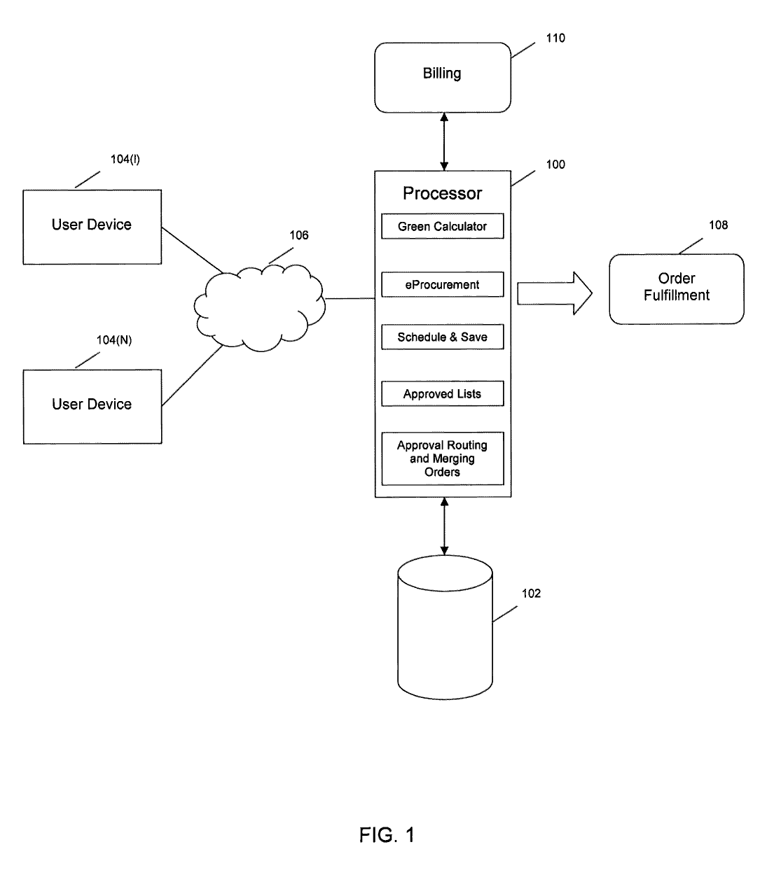

FIG. 1 is an example non-limiting computer architecture including a processor 100 coupled to a non-transitory storage device 102. The non-transitory storage device 102 stores coded instructions that when executed by the processor 100 causes the processor to perform various functions including but not limited to: (a) Green calculator; (b) Electronic procurement; (c) Schedule and save auto replenishment; (d) Approved list functionality; and (e) Approval routing and merging of orders.

In the example shown, processor 100 is accessed by any of a plurality of user devices 104(1), 104(N) (e.g., desktop computers, laptop computers, tablets, smart phones) via one or more networks 106 such as the Internet or any other signal communication path. User devices 104 may be any type of user device including for example a desktop computer, a laptop computer, a netbook computer, an ultrabook computer, a tablet computer, a smart phone, a telephone, or any other device that accepts user input and provides output. For example, devices 104 may be web-enabled to display html or xml user interface displays on one or more display screens, and accept user input such as pointing inputs from a mouse, a keyboard and/or other input device to provide selection and navigation.

In one example implementation, the processor 100 is coupled to a billing computer processor 110 that can automatically arrange for and transfer payment, and to an order fulfillment center computer processor 108 that can automatically fulfill placed orders and arrange for the delivery of goods and services to customers.

### Green Your Office; Green Your Search; Green Calculator

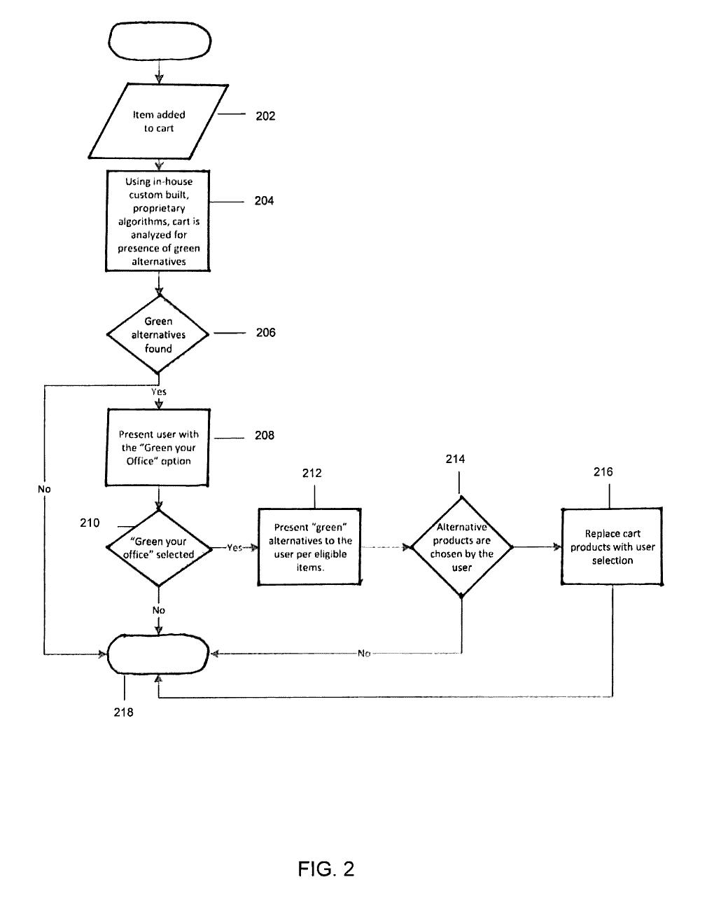

Using one example aspect of a non-limiting implementation, it is possible to convert to an eco-friendly item with the click of a mouse to proceed with a purchase. FIG. 2 is a flow chart of an example non-limiting “green your office” programmed control flow, showing the architecture of how this example non-limiting programmed control operates. Initially, when items are included in an internet shopping cart on a website 202, algorithms are utilized to analyze the contents of such customer's shopping cart for the presence of eco-friendly or green alternative products to those in the cart 204. To the extent that eco-friendly or green alternative products are available 206, then they are presented to the customer with the option to substitute those items into their shopping cart 208, and if selected “yes” exit to 210, the customer's shopping cart is automatically updated with the substituted/recommended eco-friendly or green alternative products 212, 214, 216. If the customer elects not to substitute and/or replace any such item with an available eco-friendly or green alternative, or if no alternatives are available, the customer's shopping cart remains as presently populated “No” exit to 206, 210, and the customer is directed to the next phase of the order and checkout process on the website to complete their pending transaction 218.

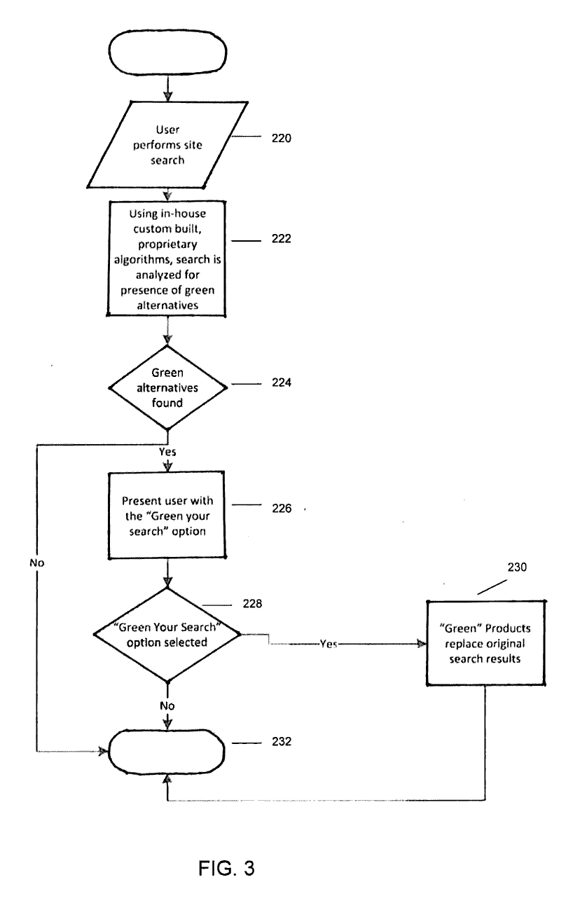

FIG. 3 illustrates a flowchart of an example non-limiting “green your search” programmed control flow, showing the architecture of how this programmed control operates in one non-limiting example embodiment. Initially, when a customer performs a product search on an example non-limiting website 220, algorithms are utilized to analyze the customer's product search for the presence of eco-friendly or green products that the website offers for sale to its customers 222. If eco-friendly or green product alternatives are available, “yes,” exit to 224. The customer will then be presented with a “green your search” option 226, which if selected will provide the customer with a responsive data set of search results consisting of eco-friendly or green products, “yes,” exit to 228, 230. If the customer declines to select the “green your search” option, “no,” exit to 228. The customer will then be presented with standard search results that best match the query inputted by the customer. From there, the customer can proceed with their commerce shopping experience on the example server's website 232.

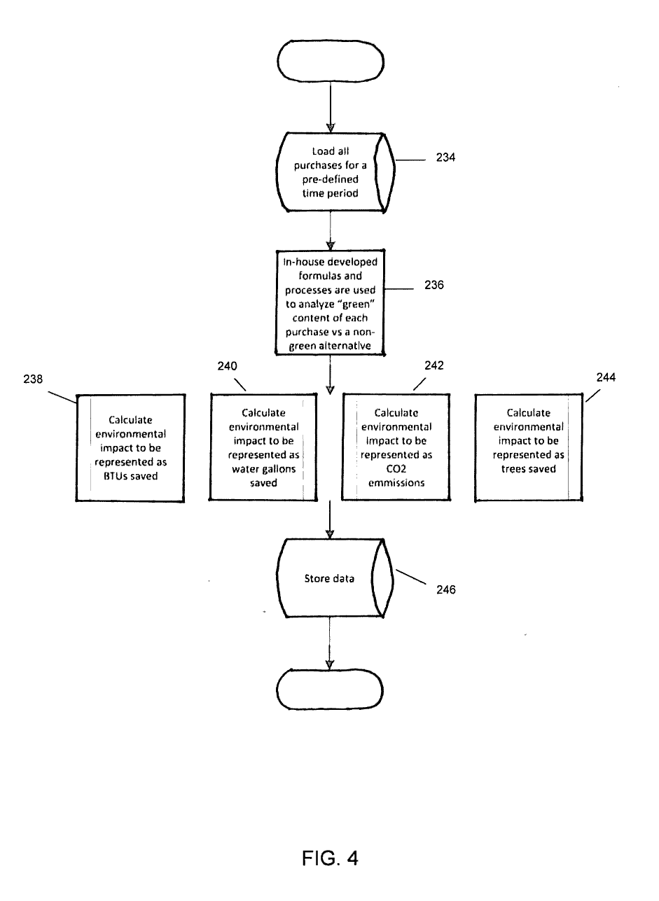

FIG. 4, illustrates a flowchart of an example non-limiting “green calculator” programmed control flow, showing the architecture of how this example programmed control operates. The example server's computer system loads all purchases made by customers on the example server's website for a pre-determined period of time into a database file stored on a non-transitory storage device 234. In-House and example formulas and processes are used to analyze the green or eco-friendly product content verses the non-eco-friendly product content for all purchases in this database file and for the programmed and pre-determined time period 236. The data produced by the example server's example formulas and processes are then used to calculate the environmental impact and savings of all such eco-friendly and green products purchased. The environmental impacts calculated and graphically represented on the example server's website are (a) BTUs saved 238; (b) gallons of water saved 240; (c) CO₂ emissions reduced 242; and (d) trees saved 244. The data is stored and periodically updated to show continually updated figures for the aforementioned environmental impacts 246.

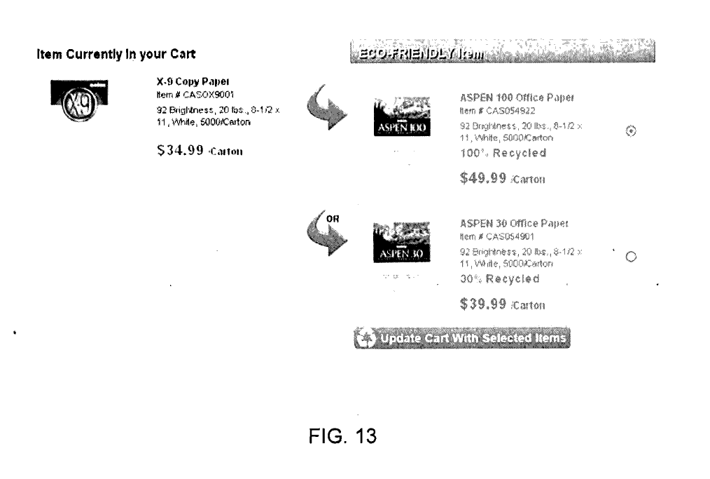

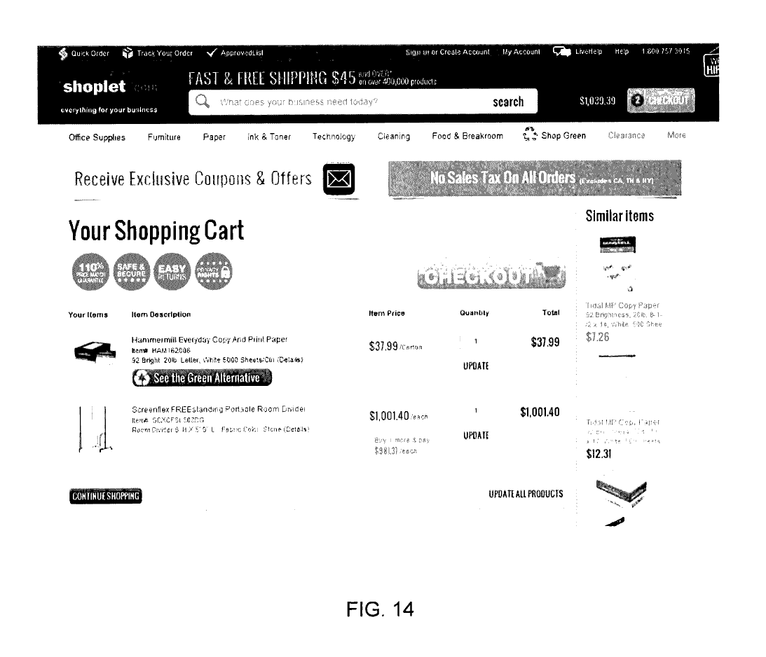

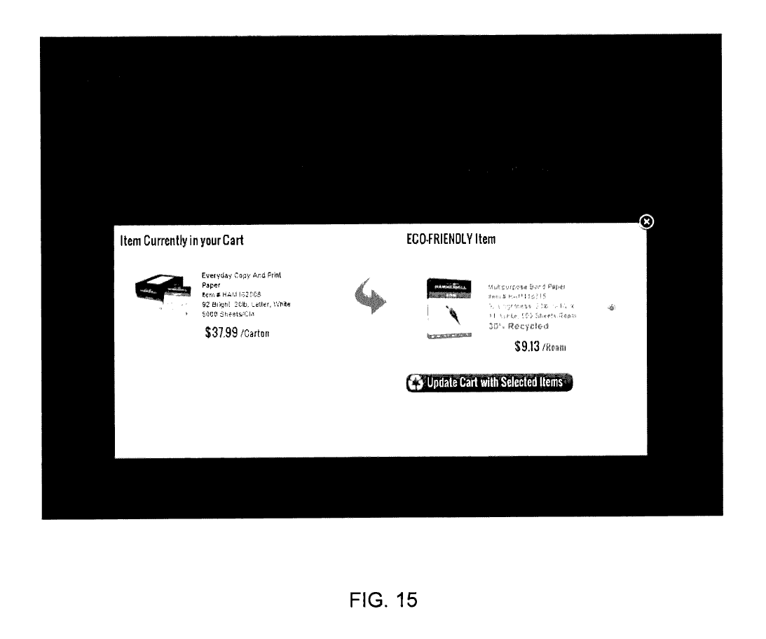

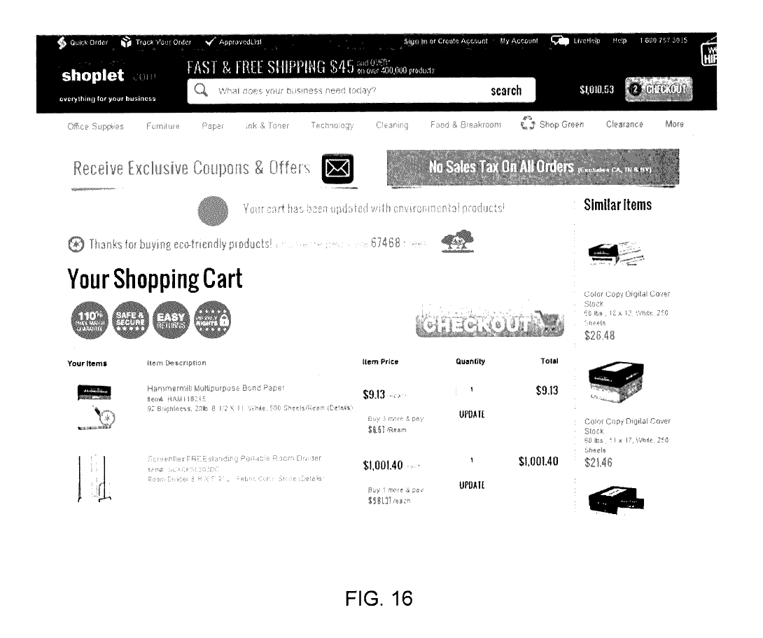

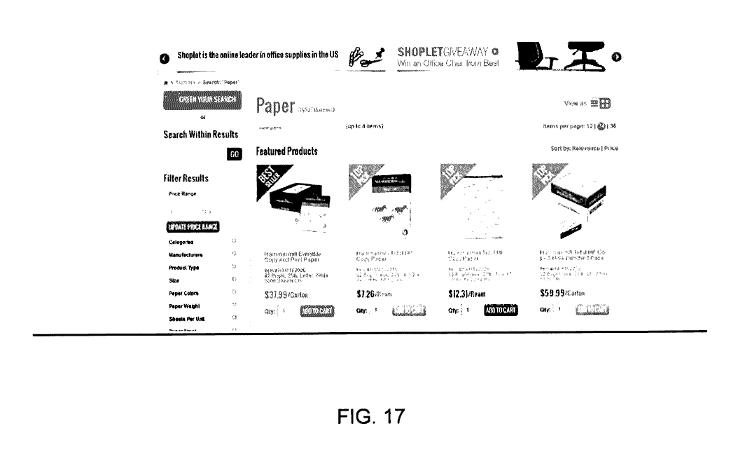

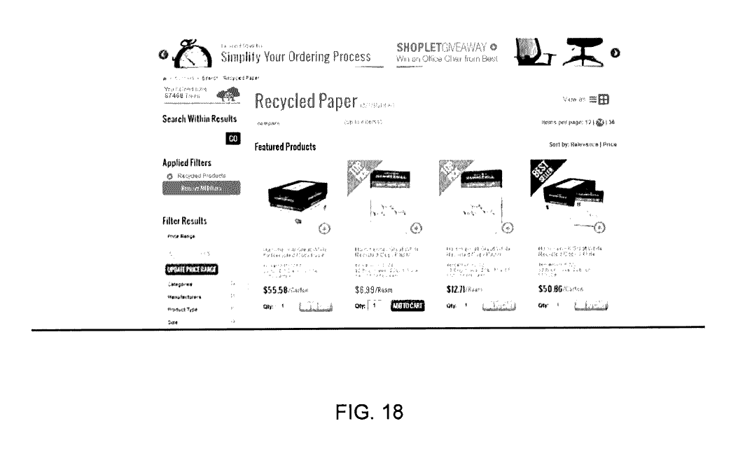

FIGS. 13 through 16 are comprised of visual descriptions and applications of an example non-limiting “green your office” web tool interface found on an internet website. FIG. 13 comprises a graphical representation of what a customer is presented when multiple eco-friendly or green alternatives exist for an item that is presently in a customer's shopping cart. The customer is presented with an actionable web interface button (“update cart with selected items”) that will enable the customer to update their shopping cart with the eco-friendly or green alternatives. FIG. 14 comprises a graphical representation of a customer's shopping cart where an item has been selected for purchase and the selected item contains an eco-friendly or green alternative. FIG. 15 comprises a graphical representation of what a customer is presented with when a eco-friendly or green alternative exists as a alternative purchase of the items placed in the users shopping cart prior to final checkout. FIG. 16 comprises a graphical representation of what a customer's shopping cart looks like after a customer has selected to “green their office” and update a cart item with an eco-friendly or green alternative. See statement “Thank you for buying eco-friendly products!).

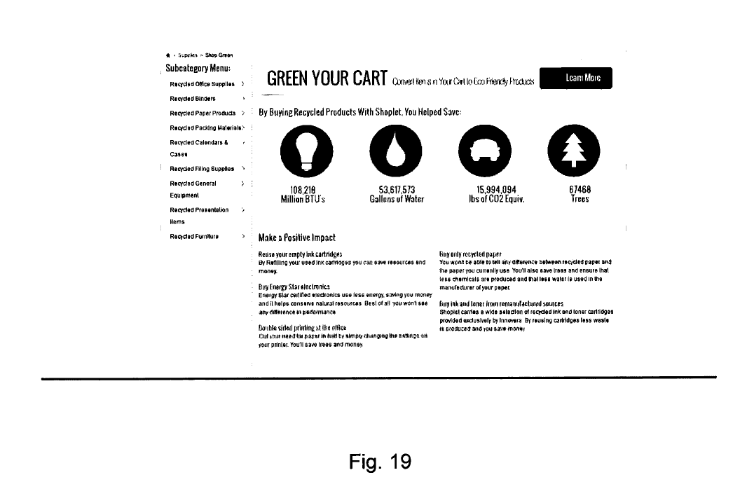

FIG. 19 illustrates a visual depiction of an example non-limiting “green calculator” interface. FIG. 19 comprises a graphical representation of the landing page on the example server's website where the statistics of the “green calculator” are publically presented to the example server's customers. On this webpage on the example server's website, customers can see the results of how their purchases of eco-friendly or green products have had a positive impact on the environment and the global initiative to conserve the planet's natural resources. The example server's “green calculator” calculates and presents to customers (a) the number of trees saved; (b) the number of BTUs saved; (c) the gallons of water saved; and (d) the pounds of CO₂ equivalent saved due in part to all such customer purchases of eco-friendly or green products from the example server.

### Electronic Procurement Platform

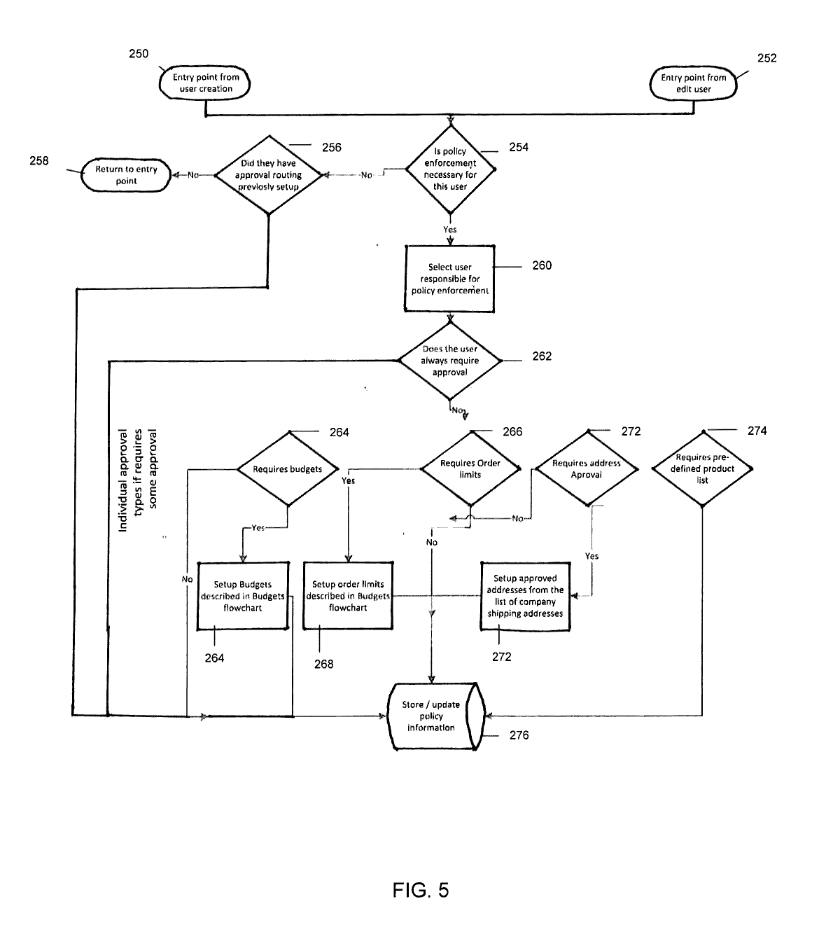

A non-limiting example and unique eProcurement solution is shown by FIGS. 5-8, 20, which consists of a suite of tools and functionality, gives businesses of all sizes the ability to streamline their buying process and make this process more efficient and cost effective. The example non-limiting eProcurement solution is a web based platform that enables customers to track and manage all of their purchases by location, by cost center, by department, by user or even by budget. Once a customer logs into their account center, they can manage their purchasing process including approving orders, tracking shipments, and printing invoices. With this example non-limiting unique and example eProcurement solution, customers can set up users in an advanced multi-tier approval hierarchy, giving each specific account user purchasing limits and rules, or the ability to place orders directly. Account users can be classified either as a requestor, which would require orders to be routed to a third party for review and approval, or as an administrator, where orders can be processed automatically, provided that they are within the guidance set and procurement parameters established by a customer through the eProcurement solution. Once an order is placed, it can be approved, declined, or even merged with other orders to streamline the ordering process. Purchasing policies, multi-level approvals, budgets, and approved lists of products can be set up for general use or for specific users. Keeping track of procurement and spending is essential to every business, and the eProcurement solution provides a reporting center that breaks down spending by all product categories or by individual users.

FIG. 5 illustrates a flowchart of an example non-limiting policies programmed control flow, showing the architecture of how this example programmed control operates. The example server's example eProcurement platform, in part, enables customers to establish purchasing policies and protocols for designated personnel. The designated personnel may be authorized by the customer to make purchases of products under a customer's account on the example server's website. When a customer adds a user to its account 250 or edits an existing user 252, the customer can select to enable a user to make purchases without any control or guidance, “no,” exit to 254. If the user is permitted to make such unrestricted purchases, the user is then permitted to purchase any and all products that are available on the example server's website 256, 258. However, should a customer require policy enforcement as part of a user's purchasing policies and protocol, “yes,” exit to 254; the customer is guided through a series of options 260-274 to create the designated policies. The customer can create purchasing budgets 262, 264, require ordering limits 266, 268, limit address approval 270, 272, and/or created designated and pre-defined lists of items that a user is approved to purchase 274. One or any combination of the aforementioned policy enforcement procedures can be uniquely implemented and stored 276 by the customer for each user that is added to or edited from a customer's account. All data points provided by a customer for any user that is added to a customer's account can, subsequent to initial setup, be amended, modified, and/or otherwise changed.

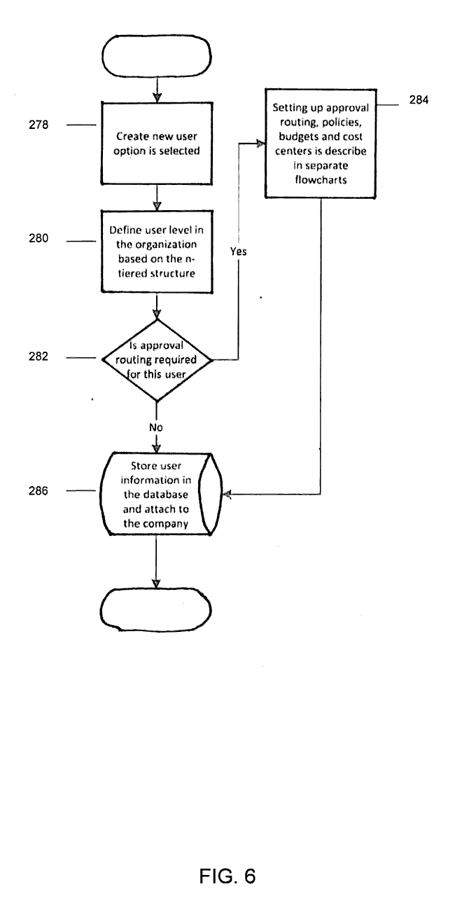

FIG. 6 illustrates a flowchart of an example non-limiting multiple users/levels programmed control flow, showing the architecture of how this example programmed control operates. The example server's example eProcurement platform, in part, enables customers to create multiple users 278 who are otherwise authorized to make and procure items from the example server's website, in connection with such customer's account with the example server. The customer, as part of the user set up process, can define a user's level in the organization based upon a tiered structure 280. A customer can decide whether approval routing is required for orders placed by such user, “yes,” exit to 282. If such approval routing is required, the customer can set up custom policies 284 as described in more detail in the description of FIG. 5. All data points provided by a customer for any user added to a customer's account are stored 286 and can, subsequent to initial setup, be amended, modified, and/or otherwise changed.

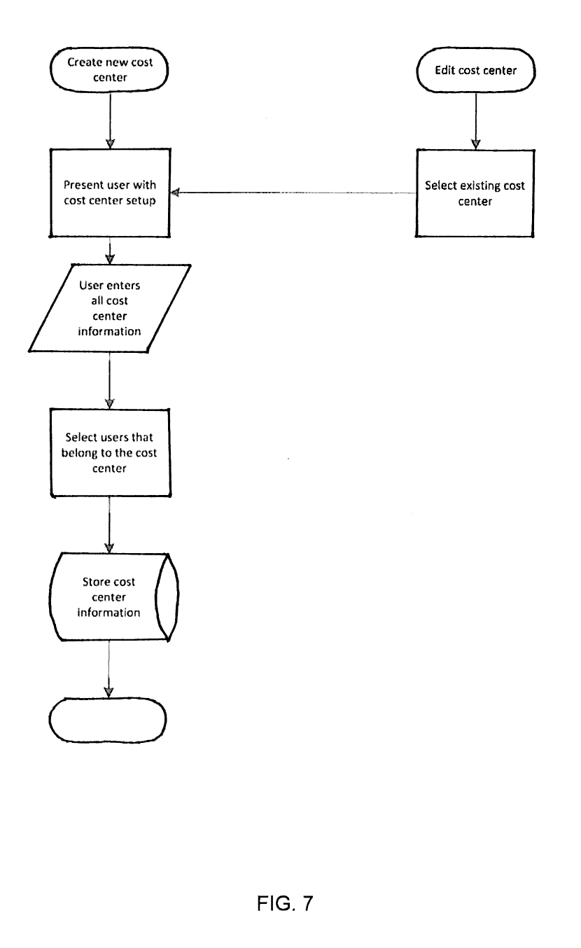

FIG. 7 illustrates a flowchart of an example non-limiting cost centers

programmed control flow, showing the architecture of how this example non-limiting control operates. The example server's eProcurement platform, in part, enables a customer to create or edit cost centers tor its designated users 288, 290, 292, 294. As part of the user setup in a customer's account center on the example server's website, the customer is presented with the option to enter cost center information 296. From there, the customer selects the users that belong to each such designated cost center 298. Such information is stored in the example server's databases 300. All data points provided by the customer relative to cost center setup can, subsequent to initial setup, can be amended, modified, and/or otherwise changed.

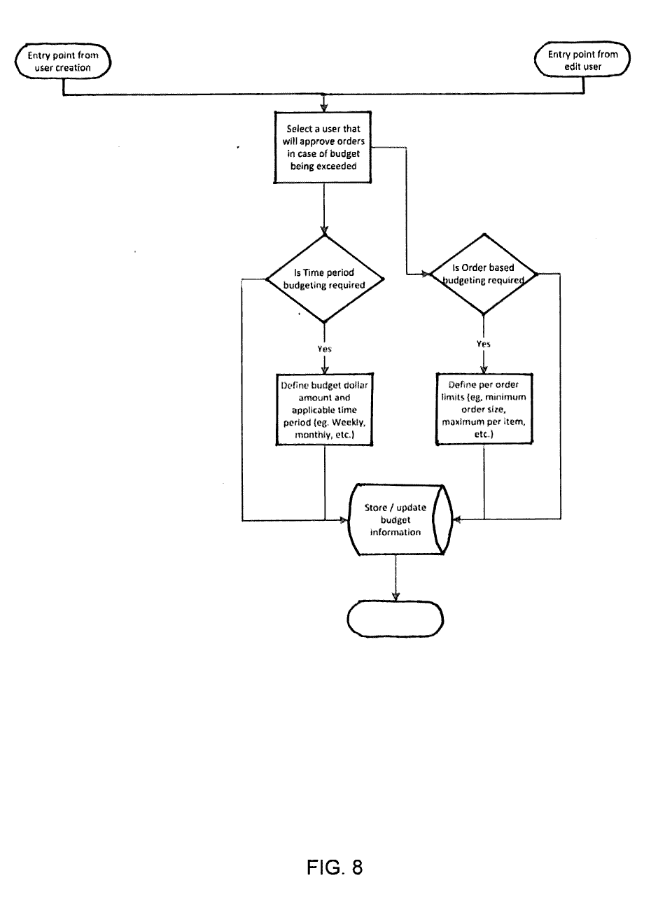

FIG. 8 provides a visual depiction of a customer's example non-limiting account center which is where all of the example tools, features and options of the eProcurement platform are navigated and utilized. In more detail, FIG. 8 is a flowchart of an example non-limiting budgets program control flow, showing the architecture of how this example non-limiting control works. The example server's example eProcurement platform, in part, enables customers to create or edit budgetary constraints and protocols for any and all users that are authorized by a customer to make purchases and/or otherwise procure items on the example server's website relative to a customer's account 302, 304. The customer will initially establish budgets for each account user. From there, the customer will select the individual who will be required to either approve or decline orders in the event that a specific user has exceeded a set budget that has been implemented by the customer 306. Budgeting can be time based 308, 310 and/or order based 312, 314. Customers may also define the budging criteria for each account user 310, 314. All data points provided by a customer are stored 316 and can, subsequent to initial set up, be amended, modified, and/or otherwise changed.

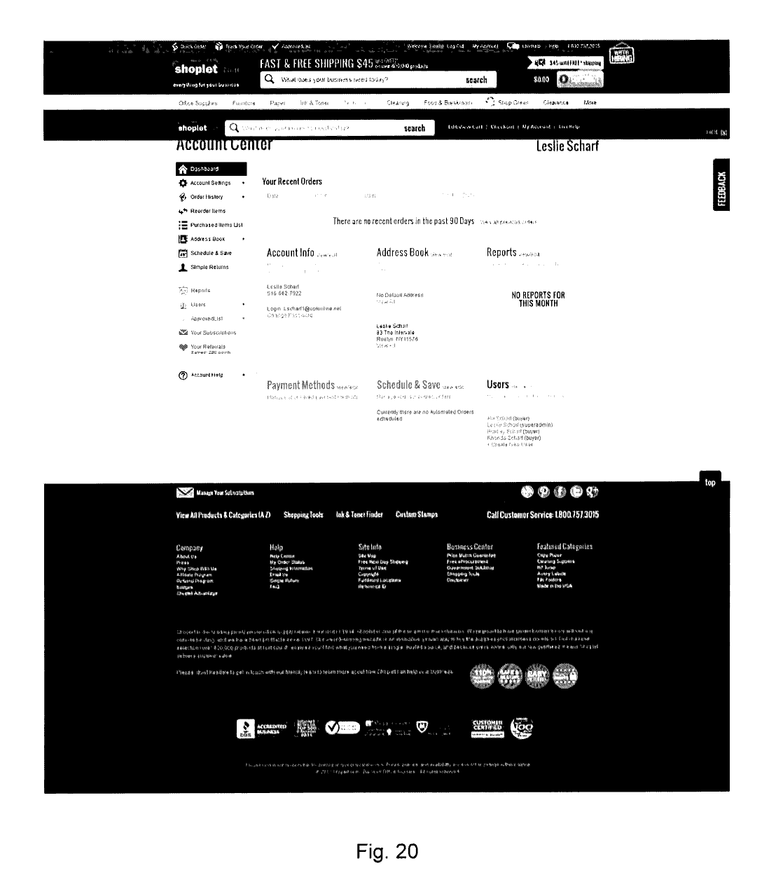

FIG. 20 illustrates a visual depiction of an example non-limiting customer's “account center” interface where all of the example tools, features, and options of the example server's eProcurement platform are accessible and may be navigated by customers. From the “account center” a customer can manage all of the key settings of their account on the example server, including but not limited to (a) Setting up and/or modifying their account settings; (b) Viewing order history; (c) Utilizing “schedule and save” functionality; (d) View, edit, and create shipping and billing addresses; (e) View, edit and create “approved lists”; (f) view, edit and create users and their procurement rules and individual settings; (h) view, edit and create user budgets; (i) view, edit and create cost centers; and (i) view and export detailed procurement reports relating to a user's account.

### Schedule & Save

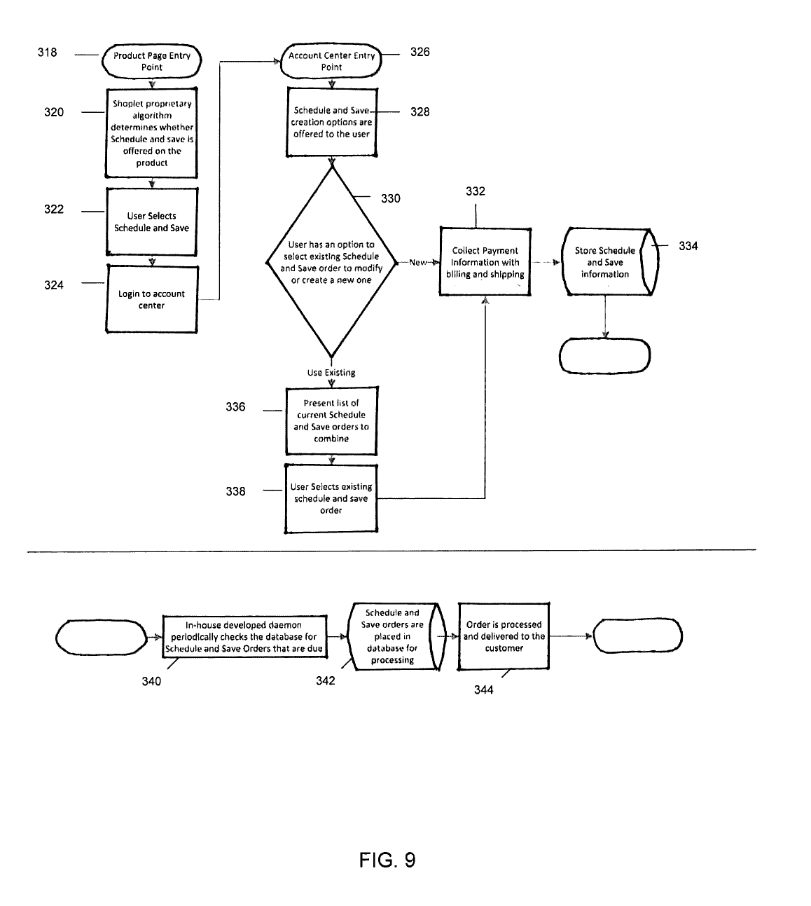

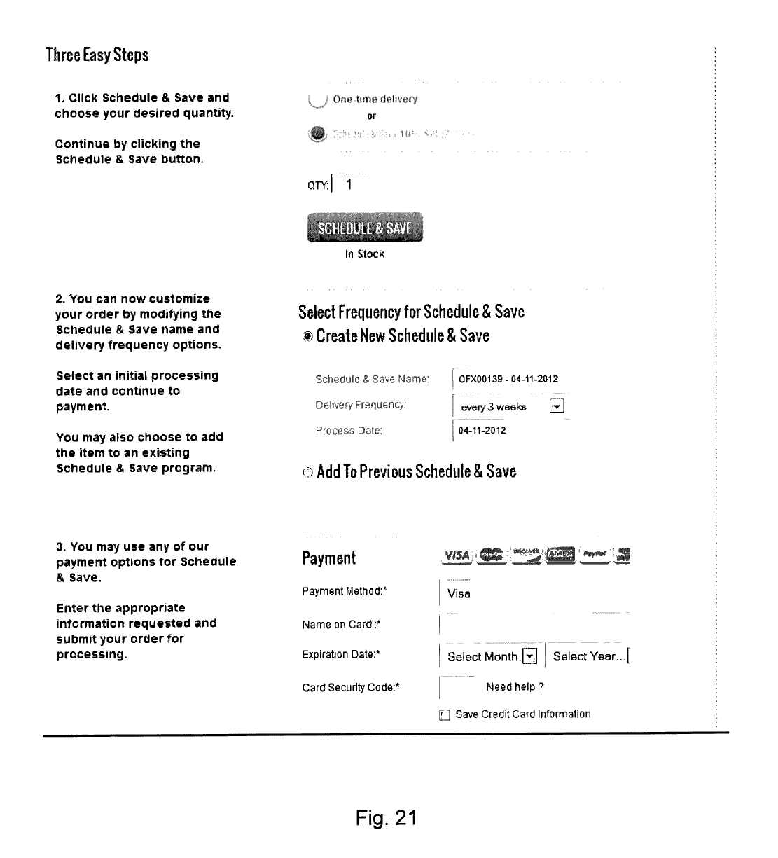

FIGS. 9, 21 illustrate a unique and example web based tool that enables customers to manage products that need to be reordered and/or purchased on a regular basis, and saves customers the time and effort of always recreating any such orders. FIG. 9 is a flowchart for an example non-limiting “schedule and save” programmed control flow, showing the architecture of how this an example non-limiting control operates. The example server's example non-limiting eProcurement platform, in part, enables a customer to select items that a customer purchases on a regular or periodic basis to be automatically ordered and delivered to a customer on a regular and customized delivery schedule. At any product page on the example server's website, algorithms and programs determine whether the “schedule and save” feature is applicable for such product 318, 320. At this point a customer (or a customer's designated account user) can select to enable the “schedule and save” feature for such product 322. If not already logged into a customer's account, the customer (or user) logs into their account and proceeds to the Schedule and Save control panel on the example server's website and follows the prompts to add a desired product to the feature 324, 326, 328. The customer can set up the delivery frequency (i.e., weekly, bi-weekly, monthly, quarterly or a custom delivery schedule) 330, and provides payment information 332, and the items will be automatically shipped for delivery as per the proscribed delivery frequency based on stored information 334. A daemon periodically checks the example server's databases for all Schedule and Save orders that are to be shipped to customers 340, and in advance of every such shipment, an email notification is sent to the customer confirming the scheduled delivery and giving the customer the opportunity to suspend or cancel any product that is scheduled to be delivered 342, 344. All data points provided by the customer can, subsequent to initial setup, be amended, modified, and/or otherwise changed.

As part of this example tool, unique architecture and algorithms identify items that are being purchased on a regular and recurring basis. Through this platform, customers simply pick products that they want to be delivered on a regular basis and then select the frequency of when each such product will be delivered—bi-monthly, monthly, quarterly, every 6 months or create a custom frequency. The customer selects a start date and such products will automatically be shipped on the prescribed frequency. This unique and example platform is configured such that the customer will always get an e-mail reminder a day before the scheduled order processing just in case the customer would like to cancel the order. The “schedule & save” web tool assures that the customer will receive all products on a regular basis, which will ultimately save the customer time, effort, and cost. All items that a customer selects to enroll into the “schedule & save” platform will still be governed by all of the spend limits, purchasing requirements, budget limits set, and cost-center parameters.

FIG. 21 comprises a graphical representation of the landing page on the example server's website where a customer goes through the input and set up process in order to utilize the example “schedule and save” auto-fulfillment feature. As represented in FIG. 21, customers go through a three step process to utilize the “schedule and save” feature—first selecting the items that the customer wants to be included; second selecting the delivery frequency, and third selecting the payment method.

### Approved Lists

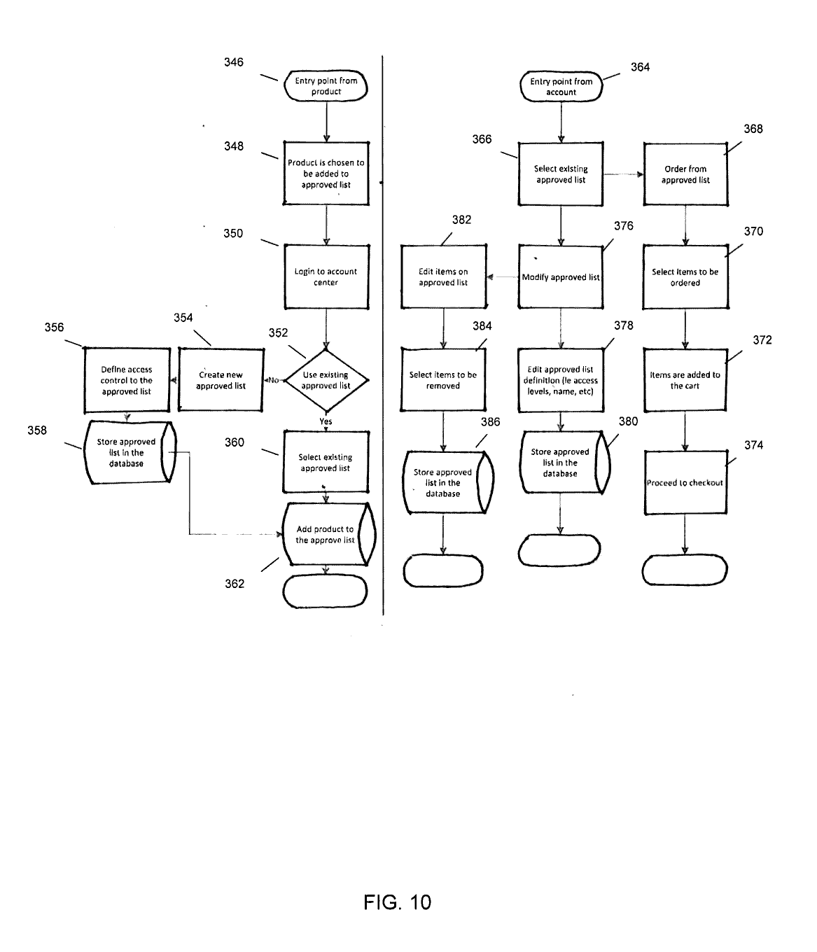

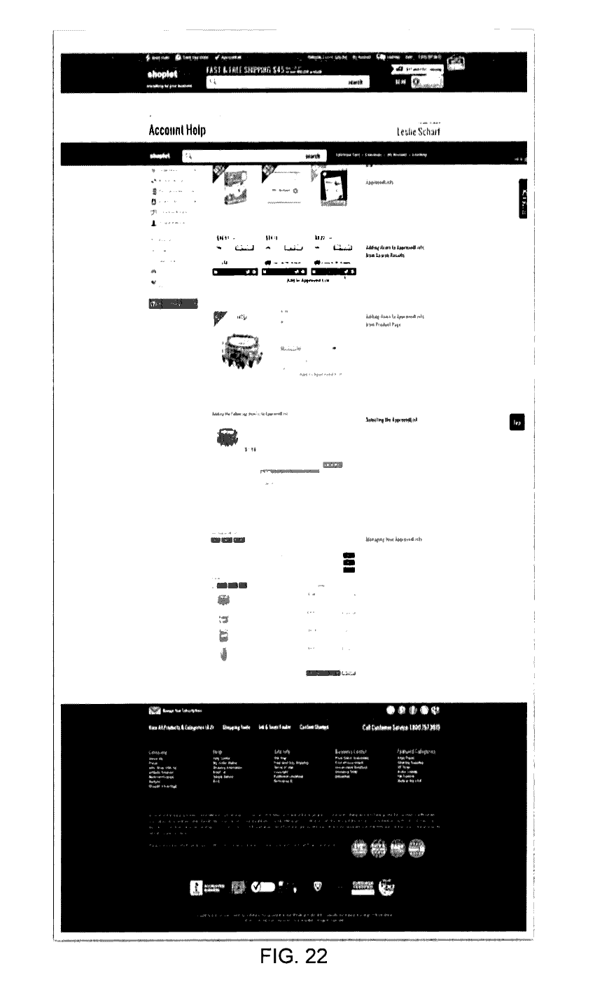

FIGS. 10, 22 illustrate an example of how a non-limiting unique web based Approved List feature enables customers to organize ail of its regularly purchased items in one place, allow for easy ordering of these items, and can help customers direct the purchase of compliant and pre-authorized items that a customer deems to be the best value for any such customer.

FIG. 10 further illustrates a flowchart of an example non-limiting “approved list” programmed control How, showing the architecture of how this example non-limiting control operates. The example server's example eProcurement platform, in part, enables customers to organize all of its regularly purchased items into one place, allow for easy ordering of these items, and help direct the purchase of compliant and pre-authorized items that a customer deems to be the best value for any such customer. From any product page on the example server's website, a customer can select an item to be added to an “approved list.” If not otherwise logged into one's account, a customer should log into their account 350, and either select to add such product to an existing Approved List 352, 360, 362 or create a new “approved list” 354. If a new “approved list” is created, the customer will be prompted to define access control to such “approved list” 356. All created “approved lists” will be stored in the example server's databases 358, 362. All selected products will be added to a customer's designated “approved list.” “Approved lists” can be edited to and/or remove products from any such list, and can be edited to modify definitions associated therewith (i.e., access levels, name etc.) 366, 382, 384. All edits and modifications to any “approved list” are stored on the example server's databases 386. Customer can also order products directly from an “approved list” 368. Select the items to be ordered which will then be added to a customer's shopping cast 370, 372. From there the customer can proceed through the designated checkout and payment processes on the example server's website 374.

As part of this unique functionality, an example non-limiting way to build an approved list is provided—just find the desired product and click the “add to the approved list” link which is at the bottom of every product page. This will allow the customer to add the item to an existing approved list or create a new one. Using this feature, a company can create company-wide approved lists that all users can access or specific lists that can only be accessed by certain users. Once an approved list has been created, customers can access it from their account center on the example server's website. Additionally and as part of this unique functionality, from an approved list, customers can create orders, edit items, or even set up products to be delivered automatically on a recurring basis through the example non-limiting “schedule & save” platform. Using the example non-limiting approved list feature saves the customer time and money while keeping control of all a customer's most commonly purchased items. All items that a customer selects to include on an approved list will still be governed by all of the spend limits, purchasing requirements, budget limits set, and cost-center parameters that are contained in and are a part, of the example non-limiting unique and example eProcurement Platform.

FIG. 22 illustrates a visual depiction of an example non-limiting “approved list” interface. FIG. 21 comprises a graphical representation of the landing page on the example server's website where a customer can create, edit and modify “approve lists” of products for their account. The “approved list” feature enables customers to organize all of their regularly purchased items in one place, allow for easy ordering of these items, and can help customers direct the purchase of complaint and pre-authorized items that a customer deems to be in the best value for any such customer.

### Approval Routing and Merging of Orders

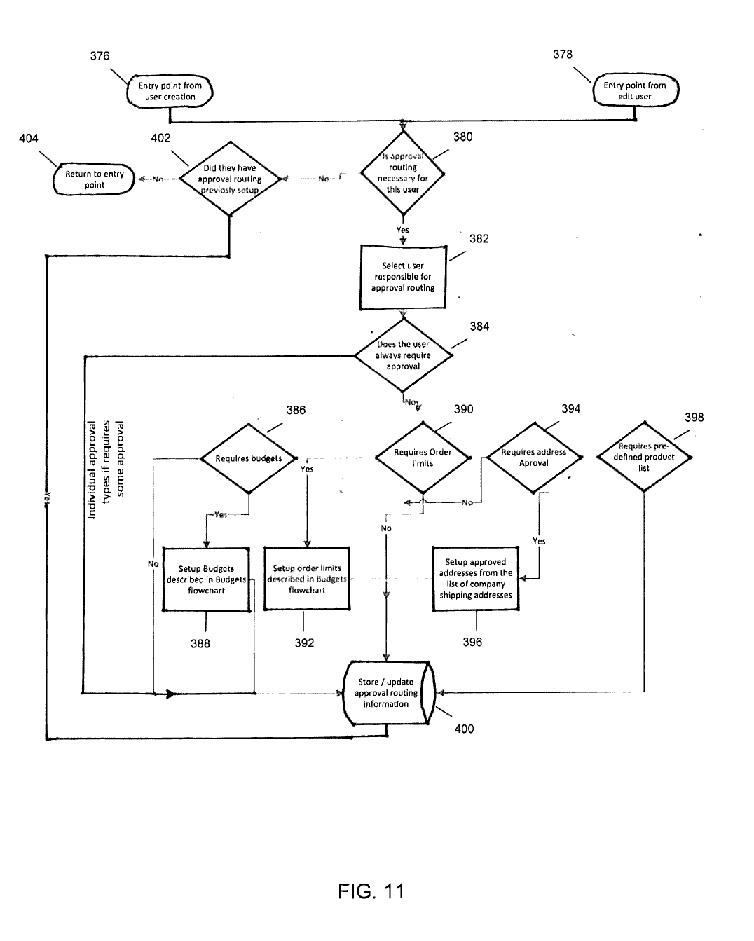

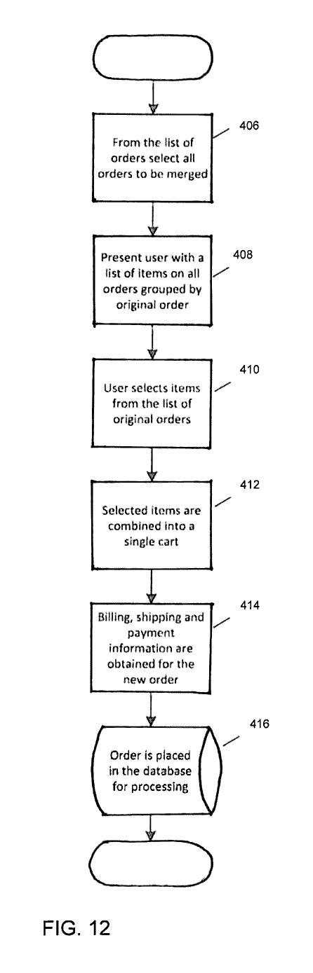

FIGS. 11, 12 & 23 illustrates an example non-limiting unique web based functionality and tools in order to enable a customer to ensure that only appropriate and compliant purchases are made by account users. FIG. 11 is a flowchart example of a non-limiting “approval routing” programmed control flow, showing the architecture of how this example non-limiting control operates. The example server's example eProcurement platform, in part, enables customers to set up order approval routing to ensure that only appropriate and compliant purchases are made by account users. From a customer's account center, a customer, as part of and adding users to their account, can determine if approval routing is necessary for each such user 380. If approval routing is unnecessary “no” exit to 380. Then the designated user will be permitted to make purchases unchecked or without any control or guidance 402, 404. If the customer determines that approval routing is necessary for any such user, “yes,” exit to 380. First the customer selects who will be designated as the responsible or approving party for all such orders placed by such user 382. Then the customer is guided through a series of options to create the desired routing approval policies 384-400. The customer can create purchasing budgets 386, 388, require ordering limits 390, 392, limit address approval 394, 396, or create designated and pre-defined lists of items that, a user is approved to purchase 398. One or any combination of the aforementioned approval routing procedures can be uniquely implemented by a customer tor each user that is added to a customer's account. All data points provided by a customer for any user added to a customer's account can, subsequent to initial set up, be amended, modified and/or otherwise changed.

FIG. 12 illustrates a flowchart of an example non-limiting Merging Orders programmed control flow, showing the architecture of how this example non-limiting control operates. The example server's example eProcurement platform, in part, enables customers to merge pending orders into a single order as a means of efficient procurement on behalf of the customer 406. From a customer's account center on the example server's website, the customer selects from a list of pending order 408, those orders that are to be merged into and processed by the example server as one single order. As part of the order merging process, the customer has the ability to select line items from all of the selected orders to be merged, as well as decline or delete any such line items, as part of the process 412. Billing, shipping, and payment information for the merged order is created by the example server's example platform 414, and the merged order is placed into the example server's databases for processing 416.

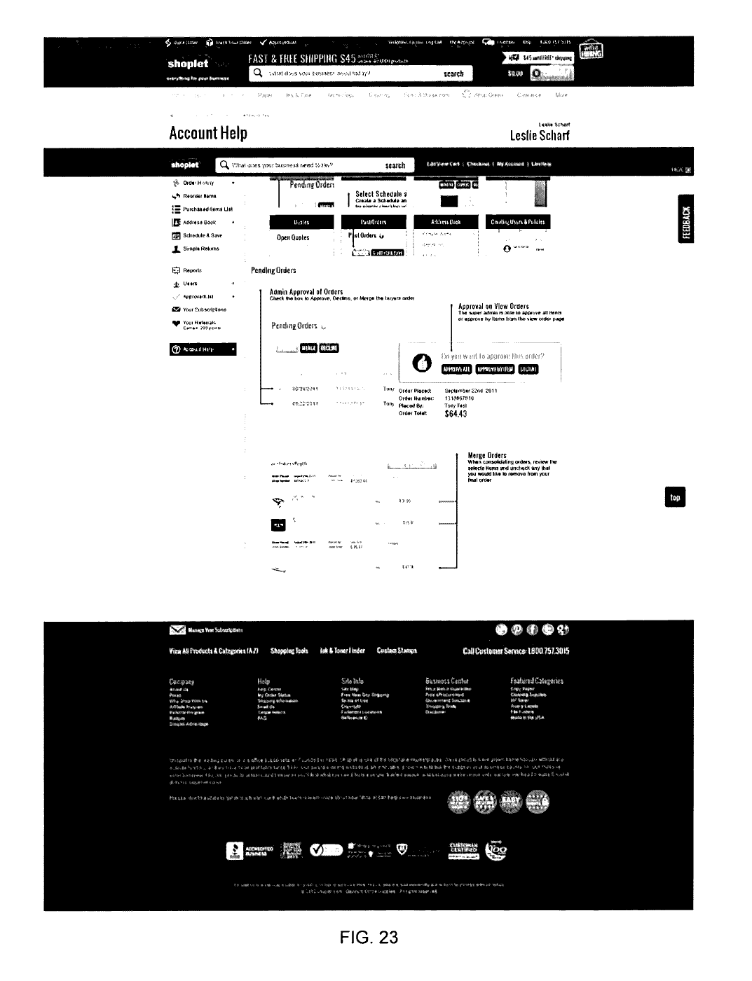

FIG. 23 illustrates a visual depiction of an example non-limiting “approval routing and merging orders” interface. FIG. 23 comprises a graphical representation of the landing page on the example server's website where a customer can (a) Approve or deny pending orders (or line items from any pending order); (b) Merge pending orders into a signal consolidated order; or (c) Set up and/or edit approval outing protocols for all users that are authorized to procure goods on he example server's website in connection with a customer's account.

These unique features will ensure that any customer that is set up as an approver of orders will get an email notification and an alert in their account center any time a user has placed an order that needs a customer's approval. Within the account center the customer can review any such orders and approve or decline the whole order, or even go to individual line items and decline only certain products from the order, that the customer does not deem appropriate. When done reviewing the order, the customer simply clicks the “approve” button and the order, in it's approved from, will be transmitted to computer 100 for processing. In addition to this unique and example functionality, system 100 includes unique example technology to enable customers to merge pending orders into a single order as a mean of enabling efficient procurement on behalf of the customer. If a customer has multiple orders from different users that need to be placed at the same time, the customer simply selects those orders and clicks the “merge” button to create one single order, which will automatically be consolidated, and processed. Additionally, this example merge order functionality enables a customer to merge line items from several pending orders to create a single merged order of only items that have been approved by the customer (with all other non-approved items being discarded from the prior pending separate orders). The customer will now only receive one delivery with one invoice. However, the accounting and tracking of the individual orders will remain separate although the individual orders have been merged, to better enable the customer to manage the reporting and budgeting for all such purchases. All items/orders that a customer approves and/or merges through these example tools and functionality will still be governed by all of the spend limits, purchasing requirements, budget limits set, and cost-center parameters that are contained in and are a part of the example non-limiting unique example eProcurement Platform.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A computer-implemented method for providing eco-friendly merchandise recommendations, the method comprising:
receiving at a server, computer product data for products offered for sale by merchants;
querying by a server to recall said product data, from a plurality of merchants in accordance with the data requested;
determining, by a processor, whether the query results had eco-friendly alternatives;
in response to determining the presence of eco-friendly alternatives, soliciting a suggestion to a user of a plurality of products related to the first product;
in response to determining the presence of eco-friendly alternatives, providing a comparison of queried results on the user's interface display;
performing a green calculator function to determine the environmental impact of said user purchase from said merchant.

2. The method of claim 1, wherein the recalled product data is further comprised of eco-friendly and non eco-friendly results.

3. The method of claim 1, wherein the solicitation of product is further comprised of a plurality of alternative suggestions.

4. The alternative suggestions of claim 3 further comprising a most eco-friendly alternative.

5. The method of claim 1, wherein the green calculator is further comprised of a real-time data updates function.

6. The green calculator of claim 5, wherein the real-time data update function is event based.

7. The green calculator of claim 5 additionally comprising a function to determine the number of trees saved, the number of British Thermal Units saved, the gallons of water saved, and the pounds of CO₂ equivalent saved.
